(19) United States
(12) Patent Application Publication
(10) Pub. No.: US 2005/0227892 A1
(43) Pub. Date: Oct. 13, 2005

(54) Fragranced bleaching composition

(75) Inventors: Anjum Fatima Shaukat, Middlesex (GB); Colin Brown, Berkshire (GB); Thomas McGee, Nyack, NY (US); Charles C. Steward, Midland Park, NJ (US); Philippe Blondeau, Paris (FR)

Correspondence Address: NORRIS, MCLAUGHLIN & MARCUS, 875 THIRD AVE, 18TH FLOOR, NEW YORK, NY, 10022, US

(73) Assignee: Givaudan SA, Vernier (CH)

(21) Appl. No.: 10/524,699

(22) PCT Filed: Aug. 20, 2003
(86) PCT No.: PCT/CH03/00565

§ 371 Date: Feb. 16, 2005

(30) Foreign Application Priority Data
Aug. 20, 2002 (GB) 02193456

(51) Int. Cl. C11D 7/18

(52) U.S. Cl. 510/302

(57) ABSTRACT

The present invention provides fragranced bleaching compositions which feature improved fragrance stability, which compositions comprise an aqueous phase, and a hydrophobic phase.

The present invention relates to fragranced bleaching compositions which feature improved fragrance stability and which permit the inclusion of a greater range of fragrance molecules.

Liquid bleaches, both hypochlorite and hydrogen peroxide-based products, are commonly used in a variety of household cleaning, disinfecting and laundering products. Fragrances have been added to liquid bleaches to impart a pleasing scent. However, many fragrance molecules are degraded by the action of the bleach. Because of the inherent ability of a bleaching agent to destroy many fragrance molecules, it is difficult to effectively perfume a bleaching composition so that the fragrance remains stable during storage and is available for effective delivery. Accordingly, there is a continued need in the art to improve upon the fragrance of bleach-containing compositions in order to satisfy the consumers' needs.

Until now, fragranced bleach compositions have been based on oil-in-water microemulsions technology. For example U.S. Pat. No. 6,114,298 discloses a fragranced disinfecting composition wherein droplets comprising an essential oil are dispersed in an aqueous phase containing disinfectant. Similarly, U.S. Re 36,982 discloses a microemulsion of a D-limonene dispersed phase in an aqueous continuous phase containing hydrogen peroxide. While both of these systems display good disinfecting properties, they are not without shortcomings. In both systems, the oil droplets are finely dispersed in aqueous media. This presents a very high phase boundary surface area, which increases the likelihood of fragrance contacting the aggressive disinfectant material. Accordingly, one may either be limited to using only those fragrance constituents that are stable in such media, which would seriously impede the creativity of the perfumers, or one will have to accept higher fragrance degradation which will affect performance and which is expensive.

Fragrance stability issues can be addressed by providing a fragranced bleach composition as two visually distinct phases, that is, a hydrophobic phase containing fragrance constituent, and an aqueous phase containing bleach constituent. Such a system essentially separates fragrance and bleach during storage. The relatively low surface area of the phase boundary compared to the oil-in-water emulsion system minimizes the incidence of fragrance constituent contacting the bleach. Prior to use however, the two phases should be mixed by shaking, thereby to dispense a fragranced bleach composition. Constituents of the hydrophobic and aqueous phase may be selected such that, after shaking and dispensing, the two phases quickly separate to further minimize contact between bleach and fragrance. A multi-phase detergent with bleach is disclosed for example in WO02/44314.

However, notwithstanding that such a system provides fragrance stability, applicant has found that the composition that is dispersed has such low viscosity that it does not cling well to the surface to be cleaned or disinfected. Whereas a person skilled in the art would add thickening agent to increase the viscosity (see for example WO02/44314) the inventors have now found a way to avoid its use by providing a fragrance bleaching composition comprising a hydrophobic phase that is a water-in-oil microemulsion instead of a single homogeneous phase.

Accordingly, the invention provides in a first aspect a fragrance bleaching composition, which composition contains at least two visually distinct phases, an aqueous phase containing a bleach constituent and a hydrophobic phase that is a water-in-oil microemulsion, the fragrance being dissolved in the oil phase. The composition when mixed and dispersed provides a viscosity such that the composition remains longer on a surface on to which it is dispensed, e.g. a viscosity of at least 5 cP.

As mentioned above, the fragranced bleaching composition of the invention may be shaken to mix the two separable liquid phases prior to application to a hard surface, or application to another substrate. The fragranced bleaching composition of the invention is characterized in that, upon standing at rest, the formation of at least two visually distinct liquid phases may be visibly observed. By the term “visually distinct” is meant that two phases are present in layers one above the other with a visible division or line of demarcation between the phases. The relative densities of the hydrophobic and hydrophilic phases will determine whether the hydrophobic phase forms an upper layer or a lower layer. Preferably, the formation of visually distinct phases occurs within about 6 hours, more preferably within about 2 to 4 hours, most preferably within 10 to 30 minutes after shaking.

The composition according to the invention may be formed by preparing the water-in-oil microemulsion separately from the aqueous phase which contains the bleach. This provides the requisite thickening, without concomitant addition of bleach to the dispersed aqueous phase. Alternatively, the water-in-oil microemulsion phase and the aqueous phase may be formed in one pot, whereupon some bleach will find its way into the dispersed phase. In such a system, it is preferred that bleach-stable fragrance constituents be employed.

The bleach constituent for use in the invention may be a single bleach or a mixture thereof. Any bleach known to those skilled in the art may be used, including any chlorine bleach as well as any peroxide bleach.

Suitable chlorine bleaches include hypochlorite compositions that yield a hypochlorite species in aqueous solution, the hypochlorite ion being chemically represented by the formula (OCl⁻). The hypochlorite ion is a strong oxidizing agent and, for this reason, materials which yield this species are considered to be powerful bleaching and/or disinfecting agents. Exemplary useful bleaching compositions which yield a hypochlorite species in aqueous solution include alkali metal and alkaline earth metal hypochlorites, hypochlorite addition products, chloramines, chlorimines, chloramides, and chlorimides. Specific examples of compounds of this type include lithium hypochlorite, calcium hypochlorite dihydrate, monobasic calcium hypochlorite, dibasic magnesium hypochlorite, chlorinated trisodium phosphate dodecahydrate, potassium dichloroisocyanurate, trichlorocyanuric acid, sodium dichlorosiocyanurate, trichlorocyanuric acid, sodium dichloroisocyanurate, sodium dichloroisocyanurate dihydrate, 1,3-dichloro-5.5-dimethylhydantoin, N-chlorosulfamide, Chloramine T, Dichloramine T, Chloramine B and Dichloramine B. Most preferably, as the hypochlorite bleach constituent, hypochlorites such as alkali metal hypochlorites, as well as hypochlorite precursors are used. Exemplary hypochlorite producing species include halogen bleaches selected from the group consisting of the alkali metal and alkaline earth salts of hypohalite, haloimines, haloimides and haloamides as the hypochlorite bleach constituent are sodium, potassium, lithium and calcium hypochlorites. Particularly preferred is sodium hypochlorite which is effective and widely commercially available.

In the embodiments of the present invention wherein the compositions comprise a peroxide bleach. A peroxide bleach is one that generates active oxygen from a peroxide linkage. One such material is hydrogen peroxide, which may be present as itself or via a source. Suitable water-soluble sources of hydrogen peroxide for use herein include percarbonates, preformed percarboxylic acids, persilicates, persulphates, perborates, organic and inorganic peroxides and/or hydroperoxides. Suitable organic and inorganic peroxides/hydroperoxides for use in the compositions according to the present invention include diacyl and dialkyl peroxides/hydroperoxides such as dibenzoyl peroxide, t-butyl hydroperoxide, dilauroyl peroxide, dicumyl peroxide, and mixtures thereof. Suitable preformed peroxyacids for use in the compositions according to the present invention include diperoxydodecandioic acid DPDA, magnesium perphthalatic acid, perlauric acid, perbenzoic acid, diperoxyazelaic acid and mixtures thereof. Further hydrogen peroxide sources which may be used in the present inventive compositions are described in detail, and which description is herein incorporated by reference, in Kirk Othmer's Encyclopedia of Chemical Technology, 4th Ed (1992, John Wiley & Sons), particularly at Vol. 4, pp. 271-300 “Bleaching Agents (Survey)”.

Accordingly, the compositions according to the present invention typically comprise from 0.1% to 20%, preferably from 0.25% to 15%, more preferably from 0.5% to 8% by weight of the total composition of an active bleach constituent or mixtures thereof.

The inventive compositions also require an a oil constituent which forms part of the hydrophobic phase containing the fragrance constituent. Preferably, the oils of the present invention are hydrophobic, and more preferably exhibit substantially no surfactant properties. The oil constituent can be any water-insoluble oil which remains in a fluid state at the temperature range experienced in household conditions (approx. 10° C. minimum, and at normal atmospheric pressure). Preferably, the oil constituent can be one or more water-insoluble oils which, at atmospheric pressure exhibit a boiling point in the range of from about 70° C.-170° C. By way of non-limiting example, water-insoluble oils may be used in the inventive compositions: paraffinic hydrocarbons, silicone oils, ester oils, sugar ester oils or oily sugar derivative, natural oils such as vegetable oils, those derived from mineral sources, those derived from petroleum sources, as well as mixtures thereof. Preferably, the water-insoluble oil has a vapor pressure of greater than 0.1 mm Hg at 25° C.

The paraffinic hydrocarbons may be a single hydrocarbon species, but that are more usually provided as technical grade mixtures of several hydrocarbon species. Such paraffinic hydrocarbons are generally described as being saturated hydrocarbons containing from 8 to 20 carbon molecules. These may be straight chained, branched or may form rings, including single rings as well as fused rings.

Further exemplary commercially available water-insoluble oils include the Esso Marcol® technical grade range of oils, such as the Silkolene® medicinal Sirius range (e.g., M40, M70, and M180). The molecular weight of such oils is typically within the range 150 to 400, and these are believed to be derived from mineral or petroleum sources.

Further oils which may be used as the water-insoluble oils in the present invention include those disclosed in WO 00/70004 and in U.S. Published Patent Application 20020055452, which is incorporated by reference as if recited in full herein. These include sugar ester oils, sucrose polyesters (SPE), and oily sugar derivatives. Preferably, the sugar ester oils are esters containing straight or branched, saturated or unsaturated carboxylic acids. A sugar ester oil or oily sugar derivative is a liquid derivative of a cyclic polyol, of a reduced saccharide or mixtures thereof, the resulting derivatives resulting from 35 to 100% of the hydroxyl groups in the polyol or in the saccharide being esterified or etherified. In the present invention, the derivative has two or more ester or ether groups independently attached to a C₈-C₂₂ alkyl or alkenyl chain. Oily sugar derivatives suitable for use in the present invention include sucrose pentalaurate, sucrose tetraoleate, sucrose pentaerucate, sucrose tetraerucate, sucrose, pentaoleate, and the like. Exemplary commercially available materials include some of the Ryoto® series available from Mitsubishi Kagaku Foods Corporation, e.g. Ryoto® ER290. Exemplary commercially available ester oils include the saturated ester oils (ex. Unichema) and the unsaturated sugar ester oils (ex. Mitsubishi Kagaku). It is preferred that the ester oils of the invention be hydrophobic. It is further preferred that the ester oil be saturated (i.e., hardened) in nature, unless it is a sugar ester oil or a plant derivative, in which case, unsaturation is preferred.

Especially useful ester oils as the water-insoluble oils in the present invention include the fatty ester of a monohydric or polyhydric alcohol having from 1 to about 24 carbon atoms in the hydrocarbon chain and monocarboxylic or polycarboxylic acids having from 1 to about 24 carbon atoms in the hydrocarbon chain, with the proviso that the total number of carbon atoms in the ester oil is equal to or greater than 16 and that at least one of the hydrocarbon radicals in the ester oil has 12 or more carbon atoms. Commercially available ester oils most suitable for use in the present invention include materials sold as PRIOLUBES® (ex. Unichema). Specific examples include, PRIOLUBE® 1407, PRIOLUBE® 1447, PRIOLUBE® 1415, PRIOLUBE® 1446, PRIOLUBE® 1427, PRIOLUBE® 1445, PRIOLUBE® 2045, PRIOLUBE® 3988, PRIOLUBE® 3987, PRIOLUBE® 2091, ESTOL® 1545, and ESTOL® 1527. Of these, ESTOL® 1545, which is a 2-ethyl hexyl stearate, is particularly useful.

Further useful as the water-insoluble oil are one or more terpene-based oils. These terpene-based oils preferably include mono- and bicyclic monoterpenes, i.e., those of the hydrocarbon class, which include, for example, the terpinenes, terpinolenes, limonenes, pinenes and mixtures thereof. Exemplary useful terpenes include d-limonene, and the mixture of terpene hydrocarbons obtained from the essence of oranges, e.g., cold-pressed orange terpenes and orange terpene oil phase ex fruit juice, and the mixture of terpene hydrocarbons expressed from lemons and grapefruit. The foregoing terpene-based oils are include derivatives of citrus fruits and citrus fruit by-products and, therefore, are naturally occurring materials. Numerous other terpene hydrocarbons are known to those skilled in the art and may be used to prepare the fragranced bleaching compositions of the present invention. Particularly useful and preferred are mixtures of terpene-based oils obtained from the essence of oranges, e.g., cold-pressed orange terpenes and orange terpene oil phase ex. fruit juice, and the mixture of terpene hydrocarbons expressed from lemons and grapefruit. Of these terpenes, d-limonene is the most preferred.

The fragranced bleaching compositions of the invention may also comprise as the hydrophobic phase or part of the hydrophobic phase a pine oil constituent. Useful pine oils which may be used as the water-insoluble oil constituent include synthetic pine oil, and also include steam distilled and sulfate pine oils, and will generally contain a higher content of turpentine alcohols. Other important compounds include alpha- and beta-pinene (turpentine), abietic acid (rosin), and other isoprene derivatives.

Particularly effective pine oils which may be used as the water-insoluble oil constituent which are presently commercially available include materials sold under the name Glidco® (Glidco Organics Corp., Jacksonville, Fla. (USA)). Other products which can contain up to 100% pure alpha-terpineol, may also be used in the present invention.

The inventors have also observed that where the water-insoluble oil constituent consists of, or includes one or more terpenes, that some or all of the fragrance constituents may be omitted. This is due to the fact that terpenes do provide some fragrancing effect The water-insoluble oil constituent may be present in the fragranced bleaching compositions taught herein in amounts of from about 0.5% by weight to up to about 50% wt., preferably from 0.5% wt. to 25% wt., and most preferably water-insoluble oils form 1% wt. to 15% wt. of the fragrance bleaching compositions of which they form a part.

According to certain preferred embodiments, the water-insoluble oil constituent is solely a d-limonene constituent, a pine oil constituent, an orange oil terpene constituent, or a paraffinic hydrocarbon.

According to certain particularly preferred embodiments, the waterinsoluble oil constituent is one or more selected from: d-limonene (boiling point approx. 154° C.); cycloparaffinic hydrocarbons (boiling point range of approx. 75° C.-85° C.) and which further preferably contain a significant proportion (i.e., in excess of 80%, preferably in excess of 90%) of cycloparaffinic hydrocarbons containing 6 carbon atoms; and isoparaffinic hydrocarbons (boiling point range of approx. 113° C.-143° C.).

Although optional, the present inventors have found that is frequently helpful to include a cosolvent in addition to the water-insoluble oil constituent. Such cosolvents can be any of variety of further hydrocarbon that liquids including for example our hydrocarbons, particularly C₂-C₆, linear, or branched alcohols or polyalcohols (glycols). When present, such can be included in any effective amount and generally, are present up to about 8% wt. based on the total weight of the fragranced bleaching compositions, but desirably are present in the range of from 4.8% wt. to 6.8% wt.

The hydrophobic phase of the inventive compositions also contains the fragrance constituent. The fragranced bleach composition according to the present invention may contain all kinds of fragrance molecules selected from the extensive range of natural and synthetic molecules currently available, such as essential oil, alcohols, aldehydes and ketones, ether and acetals, ester and lactones, macrocycles and heterocycles, and/or in admixture with one or more ingredients. However to limit the migration of the fragrance composition from the hydrophobic phase to the aqueous phase comprising the bleach constituent, water soluble fragrance molecules are preferably avoided. The aqueous solubility of a fragrance molecule is conventionally measured using a number of different procedures, for example the procedure disclosed in Etzweiler et al., Analytical Chemistry, Vol. 67, No. 3 (1995) the resulting amount being expressed in grams per gram of solution of the fragrance; or it may be determined from the partition coefficient of the fragrance between octanol and water, expressed as log P. Log P may be measured directly but more conveniently, it may be calculated from the structure of the molecule using one of the several commercially available software programs, such as ACD Software. The calculated value is abbreviated to clogP. Accordingly, preferred fragrance molecules useful in the present inventive composition have a aqueous solubility below 20000 ppm, preferably below 10000 ppm, more preferably below 5000 ppm, but most preferably below 2000 ppm. Thus, fragrance molecules, such as phenylethylalcohol and diethylmalonate are preferably to be avoided. Examples of natural and synthetic fragrance constituents which may be used in the inventive composition are listed e.g. in “Perfume and Flavor Materials of Natural Origin”, S. Arctander, Ed., Elizabeth, N.J., 1960 and “Perfume and Flavor Chemicals”, S. Arctander, Ed., Vol. I & II, Allured Publishing Corporation, Carol Stream, USA, 1994. The fragrance constituent may be present in any amount which is effective in providing a desired fragrance to a consumer product, and at the same time which is miscible within the second hydrophobic phase. Naturally, the specific amount can vary but generally good results are obtained wherein the fragrance constituent is present in at least about 0.05% wt of the bleach composition. preferably however, the fragrance constituent is present in an amount of from 0.1% wt. to 10% wt., more preferably from 0.2% wt. to 5% wt. naturally however, these ranges are provided by way of illustration, and that the lesser or even greater amounts of a fragrance constituent may be included in an inventive composition.

The compositions according to the invention include a surfactant constituent, which may be one or more surfactants. The surfactants act in whole or in part as a thickening constituent. The surfactants also may act as cleaning agent when the composition is dispensed on to a surface to be cleaned. These surfactants may utilized in their free form or may be used as salts with any salt-forming counterion known to the art. Exemplary counterions include alkali metal or alkali earth metal counterions such as Na, K, Li, Cl, as well as NH₄, amine, and the like.

The surfactant constituent may include one or more nonionic surfactants based on alkoxylated alcohols or alkoxylated phenols, as well as salt forms thereof. Exemplary useful nonionic alkoxylated alcohols and alkoxylated phenols include one or more alkoxylated phenols, such as ethoxylated phenols, as well as ethoxylated and/or propoxylated and/or butoxylated alcohols formed by condensation of either an alkyl phenol or an aliphatic alcohol with sufficient ethylene oxide and/or propylene. More preferably the alkoxylated alcohols and phenols are produced by condensation of about 4-16 (more preferably 8-13), moles of ethylene oxide, propylene oxide and/or butoxylated oxide with 1 mole of a parent compound (i.e. alkyl phenol or aliphatic alcohol).

Illustrative examples of these preferred nonionic alkoxylated phenol surfactants and/or alkoxylated alcohol surfactants include one or more of those available under the tradename of NEODOL®, presently commercially available from the Shell Oil Company; TERGITOL®, presently commercially available from Union Carbide, and POLYTERGENT®, presently commercially available from the Olin Chemical Co., and IGEPAL® presently commercially available from the Rhône-Poulenc Co. Preferably, when present, the nonionic surfactant constituent is an alkoxylated alcohol constituent which even more preferably is one or more alkoxylated primary or secondary alcohols surfactant compositions.

When present, these nonionic surfactants based on alkoxylated alcohols and/or alkoxylated phenols may be present in the fragranced bleaching compositions in amounts of from about 0.001% by weight to up to about 7% wt., preferably from 3% wt. to 6% wt., and most preferably in 4% wt. to 5% wt.

The surfactant constituent may include one or more anionic surfactants based on alkyl sulfates, as well as salt forms thereof. Generally such alkyl sulfates may be represented by the formula: 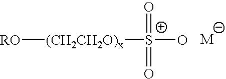
wherein:
R is an straight chain or branched alkyl chain having from about 8 to about 18 carbon atoms, saturated or unsaturated, and the longest linear portion of the alkyl chain is 15 carbon atoms or less on the average,
M is a cation which makes the compound water soluble especially an alkali metal such as sodium, or is ammonium or substituted ammonium cation, and
x has a value of from 0 to about 4.

Most preferred are the non-ethoxylated C₈₋₁₆ primary and secondary alkyl sulfates. Exemplary commercially available alkyl sulfates include those sold as RHODAPON® (ex. Rhône-Poulenc Co.) as well as STEPANOL® (ex. Stepan Chemical Co.) surfactants. Preferred alkyl sulfates include 2-ethylhexyl sulfate.

When present, these anionic surfactants based on alkyl sulfates may be present in the fragranced bleaching compositions in amounts of from about 0.001% by weight to up to about 7% wt., preferably from 0.25% wt. to 6% wt., and most preferably from 0.4% wt. to 5.5% wt.

The surfactant constituent may include one or more one or more anionic surfactants based on one or more of alkyl sulfosuccinates, alkyl ether sulfosuccinates, alkylamide sulfosuccinates, alkyl sulfosuccinamates, as well as salt forms thereof. Many such anionic surfactants are known to the art and are available from a variety of sources, including materials presently commercially available under the tradename ALKASURF® (Rhône-Poulenc Co., Princeton N.J.) as well as those presently commercially available under the tradename MONAWET® (Mona Industries, Paterson N.J.).

When present, these surfactants based on one or more of alkyl sulfosuccinates, alkyl ether sulfosuccinates, alkylamide sulfosuccinates, alkyl sulfosuccinamates or salt thereof may be present in the fragranced bleaching compositions in amounts of from about 0.001% by weight to up to about 16% wt., preferably from 2.5% wt. to 15% wt., and most preferably in 1.7% wt. to 14.1% wt.

The surfactant constituent may include one or more surfactants based on amine oxides. One general class of useful amine oxides include alkyl di(lower alkyl)amine oxides in which the alkyl group has about 10-20, and preferably 12-18 carbon atoms, and can be straight or branched chain, saturated or unsaturated. The lower alkyl groups include between 1 and 7 carbon atoms. Examples include lauryl, dimethyl amine oxide, myristyl dimethyl amine oxide, and those in which the alkyl group is a mixture of different amine oxide, dimethyl cocoamine oxide, dimethyl(hydrogenated tallow)amine oxide, and myristyl/palmityl dimethyl amine oxide.

A further class of useful amine oxides include alkyl di(hydroxy lower alkyl)amine oxides in which the alkyl group has about 10-20, and preferably 12-16 carbon atoms, and can be straight or branched chain, saturated or unsaturated. Examples are bis(2-hydroxyethyl) cocoamine oxide, bis(2-hydroxyethyl) tallowamine oxide; and bis(2-hydroxyethyl)stearylamine oxide.

Further useful amine oxides include those which may be characterized as alkylamidopropyl di(lower alkyl)amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide.

Additional useful amine oxides include those which may be referred to as alkylmorpholine oxides in which the alkyl group has about 10-20, and preferably 12-16 carbon atoms, and can be straight or branched chain, saturated or unsaturated.

Preferably the amine oxides present in the composition are alkyl di(lower alkyl)amine oxides as denoted above and which may be represented by the following structure: 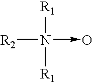
wherein each:
R₁ is a straight chained C₁-C₄ alkyl group, preferably both R₁ are methyl groups; and, R₂ is a straight chained C₁₀-C₁₆ alkyl group, preferably is C₁₂-C₁₄ alkyl group.

Each of the alkyl groups may be linear or branched, but most preferably are linear.

When present, these surfactants based on amine oxides may be present in the fragranced bleaching compositions in amounts of from about 0.001% wt. to up to about 12% wt., preferably from 2% wt. to 11% wt., and most preferably from 3% wt. to 10.1% wt. In certain preferred embodiments wherein the surfactant constituent comprises both an amine oxide and an alkali metal sulfate, these surfactants are desirably present in a respective weight ratio of 5:1.

As an adjunct to the surfactant constituent, one or more materials useful as cosurfactants may additionally be present. Examples of useful cosurfactants include long chain unsaturated fatty acids which are useful as cosurfactant, in particular C₁₆-C₁₈ unsaturated fatty acids. Preferred cosurfactants include decanoic acid, dodecanoic acid, palmitic acid, lauric acid, myristic acid, stearic acid, behenic acid, oleic acid, eicosanoic acid, tallow fatty acid, coco fatty acid, soya fatty acid, and mixtures thereof. Of these the most preferred are selected from oleic acid and lauric acid, with oleic acid being particularly preferred. When present, the cosurfactants may comprise from about 0.001% by weight to up to about 6% wt., preferably from 2.5% wt. to 5% wt., and most preferably 1.7% wt. to 4.1% wt. of the fragranced bleaching compositions of which they form a part.

The pH of the fragranced bleaching compositions according to the present invention can be from 0 to 14. In embodiments wherein the fragranced bleaching compositions comprise a peroxygen bleach, the recommended pH range of the fragranced bleaching compositions from 1 to 9, preferably from pH 1 to 8, more preferably a pH from 1 to 7 and most preferably a pH from 1 to 6. In order to achieve such a desired pH, the fragranced bleaching compositions may further comprise an acid to adjust pH. While any acid may be used, preferred are one or more organic acid, especially citric, maleic, oxalic, succinic, and tartaric acids, and similarly preferred are inorganic acids, especially sulphuric acid. Typically these acids are required only in minor amounts, and usually do not comprise more than 3% wt. of a fragranced bleaching composition of which they form a part.

In the preferred embodiment of the invention, wherein the fragranced bleaching compositions comprise a chlorine bleach, e.g., preferably an alkali metal hypochlorite, the recommended pH range of such fragranced bleaching compositions are from 8 to 14, preferably a pH of from 9 to 14, and more preferably a pH of from 9.5 to 13.5. It is in this alkaline range that the optimum bleach stability, and optimum performance of the hypochlorite is obtained; such stability and performance is attained in both undiluted (“neat”) or when the fragranced bleaching compositions are diluted. Accordingly, if appropriate, the compositions of the present invention may comprise a strong source of alkalinity. Examples of such alkaline constituents include alkali metal hydroxides, such as potassium and/or sodium hydroxide, or alkali metal oxides such as sodium and/or potassium oxide, of which sodium hydroxide is particularly preferred. When present, such alkaline constituents are preferably present in the range of from 0.04% to 5% wt., more preferably of from 0.1% to 2% wt. Desirably, one or more alkaline constituents are present in the inventive compositions comprise one or more chlorine bleaches.

The fragranced bleaching compositions may further comprise other optional constituents such as further bleach-stable surfactants (e.g., nonionic surfactants, anionic surfactants, cationic surfactants, zwitterionic surfactants and amphoteric surfactants) not already described herein, organic or inorganic alkalis, pigments, dyes, optical brighteners, solvents, buffers, builders, fragrance molecules which are bleach stable and which may be present in the aqueous phase, chelating agents, radical scavengers, stabilizers, bleach activators and the like.

For example, it is contemplated that a first bleach-stable coloring agent (pigment, and/or dyestuff) may be incorporated into the first aqueous bleach containing phase, usually included in small amounts, ultramarine blue (UMB) and copper phthalocyanines being examples of widely used bleach stable pigments which may be incorporated in the composition of the present invention. Examples are alpha- or beta-metal phthalocyanine dye, or mixtures thereof. Non-limiting examples of suitable alpha- or beta-metal phthalocyanine dyes to be used herein are bleach-stable dyes.

Another class of optional compounds for use herein include chelating agents or mixtures to deactivate trace catalytic impurities, thereof. Exemplary suitable phosphonate chelating agents for use herein may include alkali metal ethane 1-hydroxy diphosphonates (HEDP), alkylene poly(alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities.

Polyfunctionally-substituted aromatic chelating agents may also be useful in the compositions herein, as for example described in U.S. Pat. No. 3,812,044 to Connor et al., the contents of which are herein incorporated by reference. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof.

One class of stabilizer, particularly suitable for use with hydrogen peroxide are sodium stannate, sodium nitrate, and diethylene triamine penta(methylenephosphonic acid) as disclosed in U.S. Pat. No. 5,523,012 to Winterton et al., the contents of which are herein incorporated by reference. When present, such a stabilizer is present in an amount of not in excess of 10% wt. of the active bleach constituent, but desirably are present from 0.03% wt. to 5% wt. of the active bleach constituent.

Buffers preferably comprise one or more of a pH adjusting agent effective to adjust or to maintain the pH of a solution, suitable pH adjusting agents, are well known to the art and include, for example, for hypochlorite carbonates, borates, phosphates, silicates, and bicarbonates, for peroxide bleach combinations of monobasic sodium phosphate and dibasic sodium phosphate. Other satisfactory buffer systems may be employed which give substantially equivalent results in buffering.

The invention may further optionally include a cationic surfactant, specifically, a quaternary ammonium surfactant which has bacteriostatic or disinfectant properties.

Exemplary quaternary ammonium salts include the alkyl ammonium halides such as cetyl trimethyl ammonium bromide, alkyl aryl ammonium halides such as octadecyl dimethyl benzyl ammonium bromide, N-alkyl pyridinium halides such as N-cetyl pyridinium bromide, and the like. Especially preferred quaternary ammonium salts have germicidal properties.

The germicidal constituent may be present in any effective amount, but generally need not be present in amounts in excess of about 5% wt. based on the total weight of the fragranced bleaching composition of which they form a part. The preferred germicidal cationic surfactant(s) may be present in the concentrated liquid disinfectant compositions in amounts of from about 0.001% by weight to up to about 5% by weight, very preferably about up to 2. % by weight.

Other conventional but optional additives may be added in art required quantities. An example for such an optional additive is a thickener which may be added in an amount which is much less than need to achieve a viscosity of at least 5 cP when the composition is mixed, which is required by the present invention.

According to certain particularly preferred embodiments, the fragranced bleaching compositions do not include a fabric softening constituent especially those based on quaternary ammonium compounds which contain a carbonyl moiety, such as disclosed, inter alia, in WO 01/98450.

The fragranced bleaching compositions taught herein are largely aqueous, and water is included in order to comprise a quantum sufficient (q.s.) so to provide to 100% wt. Desirably, water comprises up to 75% wt., preferably from 40% wt. to 60% wt. of the total amount of the fragranced bleaching compositions. The water may be tap water, but is preferably distilled and is most preferably deionized water. If the water is tap water, it is preferably substantially free of any undesirable impurities such as organics or inorganics, especially the minerals salts which are present in hard water.

Fragranced bleaching compositions of the present invention can be prepared in a conventional manner such as by simply mixing the constituents in order to form the desired composition. However, it may in certain circumstances be desired to first combine the fragrance composition with the water-insoluble oil to form a first premixture, and separately combine all of the constituents forming the aqueous phase to form a second premixture, and then subsequently with appropriate stirring combine the first premix with the second aqueous phase in order to form a fragrance bleaching composition according to the present invention. Yet more preferably however, all of the constituents other than the water-insoluble oil constituent and the fragrance constituent are added to a portion of (or to the total amount) of water, and then well mixed to form a first premixture. Desirably, under moderate stirring, any alkaline constituents are first added to the water, followed by the surfactants, followed by the bleach constituent and then by any remaining amount of water. This mixture is stirred until uniform; generally in laboratory scale equipment, such is attained after approximately 15 minutes of continuous stirring. A second premixture is produced comprising the water-insoluble oil constituent and the fragrance constituent which is separately well stirred until the fragrance is uniformly mixed in water-insoluble oil constituent. Thereafter this second premixture is added to the first premixture under stirring, and stirring is continued for a further period until uniform, after which fragrance bleaching composition is ready for use. Even more preferably, all of the solvents, cosurfactants and surfactant constituents with the exception of bleach-stable surfactants are added to a smaller portion of the water, e.g. about 35% wt of the total amount of water, comprising a smaller portion of any alkaline constituent, e.g. about 15% wt of the total amount of alkaline constituent, and then well mixed to form a first premixture. A second premixture is produced, comprising the water-insoluble oil constituent and the fragrance constituent, which is separately well stirred until the fragrance is uniformly mixed in the water-insoluble oil constituent. Thereafter the second premixture is added to the first premixture under stirring, forming a third premixture. The bleach-stable surfactant constituents are added to the remaining portion of water comprising the remaining portion of any alkaline constituent and then well mixed to form a fourth premixture. The third premixture is then added with stirring. Finally the bleach constituent is added under stirring, after which the fragrance bleaching composition is ready for us. Upon standing at rest, the formation of at least two visually distinct liquid phases may be visibly observed

Several key technical benefits are enjoyed by the fragranced bleaching compositions of the invention. First, due to the separation into distinct and visible phases, the fragrance constituent is separated from the bleach, essentially all of which remains in the aqueous phase. Such accounts for the improved fragrance stability of the fragranced bleaching compositions as well. As has been noted above, bleaching constituents are typically deleterious to fragrance constituents, and this phase separation provided by the inventive compositions ensures the stability and duration of the fragrance constituent. Additionally, due to this phase separation, the fragrance constituent is separated from contact with the bleach and is thereby “protected”, and this permits the use of virtually all known art fragrance molecules in the present inventive compositions. Most of the fragrances are oil-soluble and thus can form part of the hydrophobic phase. However, water-soluble, bleach-stable fragrances may also be used as optional ingredients as described above. Preferably however, essentially all of the fragrance constituent will partition in the hydrophobic phase and only relatively low amounts of fragrances will be present in the hydrophilic phase. By “essentially all” is meant about 90% wt. or more, more preferably about 95% wt. or more, e.g. 98-99.5% wt. Secondly, due to the separation into distinct phases, it is foreseen that such can be attractive from a consumer standpoint. For example, different coloring agents could be provided to each of the separate phases, and when the fragranced bleaching composition is permitted to stand and separate, an attractive product having at least two different colors is made available to the consumer. Furthermore, given that substantially all of the fragrance constituent is located in a hydrophobic phase which, and when permitted to stand, forms a layer above the aqueous phase after phase separation, the user is presented with an sudden exposure to fragrance, a “burst of fragrance”, upon opening a package, e.g. a bottle, containing a composition according to the present invention, compared with aqueous dispersion systems, wherein the fragrance constituent is dispersed throughout the composition in a less concentrated manner. Such a burst of fragrance is an olfactory attribute highly desired from a consumer standpoint. Additionally, as it is typically required that the fragranced bleaching compositions be shaken by a consumer before use, appropriate selection of colors to form attractive blends having a different color could be viewed as being commercially attractive, and also as an indicator of a proper amount of mixing to a consumer.

In a further aspect of the invention, there are provided processes for improving the fragrance stability of liquid bleach containing compositions, which processes contemplate the steps of forming a bleaching composition in accordance with any of the aspects of the present inventive teaching. The resultant fragranced bleaching compositions feature good stability of any fragrance constituents present in the compositions.

The fragranced bleaching compositions according to the present invention are useful in the bleaching of an article, for example, a porous article such as a textile, garment or fabric, by contacting the article with a bleaching effective amount of the fragranced bleaching compositions being described herein.

The fragranced bleaching compositions according to the present invention may also be used in the sanitizing and/or bleaching of non-porous articles or surfaces, such as a hard surfaces and the like, by contacting these surfaces with a sanitizing effective and/or bleaching effective amount of one or more of the fragranced bleach compositions described herein. Exemplary hard surfaces include surfaces composed of refractory materials such as: glazed and unglazed tile, brick, porcelain, ceramics as well as stone including marble, granite, or other stones surfaces; glass; metals; plastics e.g. polyester, vinyl; fiberglass, Formica®, Corian® and other hard surfaces. In such an application, the water-insoluble oil phase is preferably selected to have a vapor pressure greater than 0.1 mm mercury at 25° C. so as to not to leave an oily feel on the surface.

As has been described herein, the fragranced bleaching compositions according to the present invention provide for a unique composition which is very adaptable to be used and formulated for consumer use. The final phase separation of these fragranced bleaching compositions upon standing, particularly after approximately 4-6 hours, provides products which can be formulated to be very attractive both on a store shelf, as well as in a consumer's home. The phase separation of the fragranced bleaching compositions also acts to protect the fragrance constituent, and as has been previously described, now permits for the use of fragrance constituents which had previously been impossible, or impractical for use within bleach containing compositions.

The following examples below illustrate exemplary formulations, including certain preferred embodiments of the fragranced bleaching compositions according to the instant invention. It is to be understood that these examples are presented by means of illustration only and that further useful formulations fall within the scope of this invention and the claims may be readily produced by one skilled in the art and not deviate from the scope and spirit of the invention.

The viscosity as used within the context of the invention was measured by using a Brookfield LVF viscometer, using spindle #2, at 60 RPM at 20° C., whereby the 1 cP is equal to 1 mPa·s.

### EXAMPLES A TO H

Compositions representative of the inventive compositions are provided in Table 1.

TABLE 1

| | Example | | | | | | | |
|---|---|---|---|---|---|---|---|---|
| | A | B | C | D | E | F | G | H |
| sodium hypochlorite | 14.10 | 14.10 | 14.10 | 15.52 | 15.53 | 14.10 | 15.52 | 15.52 |
| (12% active) | | | | | | | | |
| sodium hydroxide (50% active) | 1.31 | 1.31 | 1.31 | 1.31 | 1.31 | 1.31 | 1.31 | 1.31 |
| isopropanol | 5.33 | 5.33 | 5.33 | 5.33 | 5.00 | 5.33 | 5.33 | 5.33 |
| oleic acid | 1.78 | 1.78 | 1.78 | 1.78 | 1.78 | 1.78 | 1.78 | 1.78 |
| alkoxylated linear alcohol | 3.11 | 3.11 | 3.11 | 3.11 | 3.11 | 3.11 | 3.11 | 3.11 |
| alkoxylated fatty alcohol | 1.33 | 1.33 | 1.33 | 1.33 | 1.33 | 1.33 | 1.33 | 1.33 |
| amine oxide (30% active) | 9.92 | 9.92 | 9.92 | 9.92 | 9.92 | 9.92 | 9.92 | 9.92 |
| sulfosuccinate | 1.78 | 1.78 | 1.78 | 1.78 | 1.78 | 1.78 | 1.78 | 1.78 |
| sulfate | 1.47 | 1.47 | 1.47 | 1.47 | 1.47 | 1.47 | 1.47 | 1.47 |
| isoparaffinic hydrocarbon | 11.11 | — | — | — | — | — | — | — |
| d-limonene | — | 11.31 | 11.31 | — | — | — | — | 5.00 |
| pine oil | — | — | — | — | — | 11.31 | 5.00 | — |
| orange oil terpene | — | — | — | 5.00 | — | — | — | — |
| cycloparaffinic hydrocarbons | — | — | — | — | 5.00 | — | — | — |
| fragrance | 0.20 | 0.30 | — | — | 0.30 | — | — | — |
| deionized water | q.s. | q.s. | q.s. | q.s. | q.s. | q.s. | q.s. | q.s. |

Each individual composition was produced in accordance with the following general protocol. First, the deionized water was provided to a standard laboratory mixing vessel which included a conventional electrically powered rotary agitator, whose shafts and propeller blades extended downwardly into the mixing vessel. The rotary agitator was started, and with moderate stirring the sodium hydroxide was first added and the composition was mixed until homogenous. Next, under continued stirring, the following constituents were added to the contents of the mixing vessel in the following order: isopropanol, oleic acid, the alkoxylated linear alcohol, the alkoxylated fatty alcohol, the sulfosuccinate, the amine oxide, and the sulfate. (In some cases not all of these constituents were used.) Stirring was permitted to continue until the mixture was homogenous, after which the stirring was permitted to continue for a further 10 minutes, than adding the bleach constituent. During this time interval, a premixture was produced in a different, but similar standard laboratory mixing vessel including a conventional electrically powered rotary agitator by combining the water-insoluble oil constituent, with the fragrance. It will be realized that the water-insoluble oil constituent varied amongst the individual formulations, and was one of: isoparaffinic hydrocarbons, d-limonene, pine oil, orange oil terpenes, or cycloparaffinic hydrocarbons. Make sure that the water-insoluble oil constituent and the fragrance was thoroughly mixed until homogenous, after which it was introduced to the aqueous mixture in the first mixing vessel under stirring. Again, stirring was continued until the mixture appeared homogenous, and thereafter stirring continues for a further 10 minutes. Afterwards, the fragranced bleaching composition thus produced was removed from the standard laboratory mixing vessel. Upon standing at rest the formation of at least two visually distinct liquid phases is observed. Details are given in Table 8 below.

The viscosity of the compositions produced on Table 1 was evaluated at ambient room temperature (20° C.) using a Brookfield LVF viscometer, using spindle #2, at 60 RPM; each of the formulations was manually shaken prior to testing. The results were reported in centipoise-seconds (cP), and are listed on Table 2.

TABLE 2

| Example | Viscosity (cP) |
|---|---|
| A | 55-65 |
| C | 45-55 |
| D | 30-40 |
| E | 45-55 |

### EXAMPLES I TO M

Compositions representative of the further aspect of the inventive compositions, wherein the water-insoluble oil is a conventional fragrance constituent are provided in Table 3.

TABLE 3

| | Example | | | | |
|---|---|---|---|---|---|
| | I | J | K | L | M |
| sodium hypochlorite (12% active) | 22.50 | 14.56 | 17.26 | 17.26 | 22.50 |
| sodium hydroxide (50% active) | 1.3 | 1.3 | 1.3 | 1.3 | 1.3 |
| sulfosuccinate | 14 | 14 | 14 | 14 | 14 |
| sulfate | 2 | 5 | 2 | 2 | 2 |
| d-limonene | 10 | 15 | 10 | 10 | 2 |
| isopropyl myristate | 10 | — | — | — | |
| isoparaffinic hydrocarbons | — | — | — | — | 8 |
| fragrance | — | — | — | 0.20 | 0.3 |
| deionized water | q.s. | q.s. | q.s. | q.s. | q.s. |

Each individual composition of Table 3 was produced in accordance with the general protocol described with reference to the compositions of Table 1. It is to be noted that the fragrance constituent in Example I to K was satisfied by the presence of the d-limonene but which provided a citrus scent to the overall compositions, and which also functioned as at the water-insoluble oil constituent. Additionally, one of the formulations also included isopropyl myristate (supplied as CRODAMOL® IPM, above 98% wt. actives, ex. Croda Oleochemicals Ltd. Goole, East Yorkshire, UK) or isoparaffinc hydrocarbon respectively which functioned in the compositions of Table 3 as a water-insoluble oil constituent. The remaining constituents in the formulations of Table 3 are described in Table 8.

The viscosity of the compositions produced according to Table 3 was evaluated at ambient room temperature (20° C.) using a Brookfield LVF viscometer, using spindle #2, at 60 RPM; each of the formulations was manually shaken prior to testing. The results were reported in centipoise-seconds, and are listed on Table 4.

TABLE 4

| Example | Viscosity (cP) |
|---|---|
| I | 10 |
| J | 7.5 |
| K | 7.5 |

### EXAMPLE N TO Y

Further compositions representative of the inventive compositions prepared according to the most preferable process are provided in Table 5. Each individual composition was produced in accordance with the following general protocol. First a portion of 35% wt deionized water was provided to a standard laboratory mixing vessel. The rotary agitator was started, and with moderate stirring 15% wt the sodium hydroxide was added and the composition was mixed until homogenous. Next, under continued stirring, the following constituents were added to the contents of the mixing vessel in the following order: isopropanol, oleic acid, the alkoxylated linear alcohol, the alkoxylated fatty alcohol, the alcohol ethoxylate and the sulfosuccinate (In some cases not all of these constituents were used.). Stirring was permitted to continue until the mixture was homogenous. During this time interval, a premixture was produced in a different, but similar standard laboratory mixing vessel including a conventional electrically powered rotary agitator by combining the water-insoluble oil constituent (isoparaffinic hydrocarbon or d-limonene), with the fragrance. This premixture was then introduced to the aqueous mixture in the first mixing vessel under stirring. Stirring was continued until the mixture appeared homogenous, and thereafter stirring was continued for a further 10-15 minutes. During this time interval or afterwards, the remaining portion of deionized water was provided in a different mixing vessel and with moderate stirring the remaining portion of sodium hydroxide was added and the composition was mixed until homogenous. Next, under continued stirring, the following constituents were added to the contents of the mixing vessel in the following order: the sulfate, the amine oxide C₁₂-C₁₈, the Na n-decyl diphenyloxide disulphonate, and the Na dodecyl diphenyloxide disulphonate. Stirring was continued until the mixture appeared homogenous, and thereafter stirring was continued for a further 10-15 minutes, the bleaching constituent then being added. Finally, DPM was added. Afterwards, the fragranced bleaching composition thus produced was removed from the standard laboratory mixing vessel. Upon standing at rest, the formation of at least two visually distinct liquid phases was observed. Details with respect to the individual constituents are given in Table 8 below. The same laboratory equipment was used as described in more detail in Example A to H.

TABLE 5

| | Example | | | | | | | | | | | |
|---|---|---|---|---|---|---|---|---|---|---|---|---|
| | N | O | P | Q | R | S | T | U | V | W | X | Y |
| sodium hypochlorite (12% active) | 18.00 | 18.00 | 18.00 | 18.00 | 18.00 | 18.00 | 18.00 | 18.00 | 16.15 | 17.41 | 17.36 | 18.26 |
| sodium hydroxide (50% active) | 1.31 | 1.31 | 1.31 | 1.31 | 1.31 | 1.31 | 1.31 | 1.31 | 1.31 | 1.31 | 1.31 | 1.31 |
| isopropanol | 5.33 | 6.33 | 5.33 | 5.33 | 5.33 | 5.33 | 5.33 | 5.33 | 5.33 | 5.33 | 5.33 | 5.33 |
| oleic acid | 1.78 | 1.78 | 1.78 | 1.78 | 1.78 | 1.78 | 1.78 | 1.78 | 1.78 | 1.78 | 1.78 | 1.78 |
| alcohol ethoxylate | 4.44 | 4.44 | 4.44 | 4.44 | 4.44 | 4.44 | 4.44 | 4.44 | — | — | — | — |
| aloxylated linear alcohol | — | — | — | — | — | — | — | — | 3.11 | 3.11 | 3.11 | 3.11 |
| alkoylated fatty alcohol | — | — | — | — | — | — | — | — | 1.33 | 1.33 | 1.33 | 1.33 |
| sulfosuccinate | 1.78 | 1.78 | 1.78 | 1.78 | 1.78 | 1.78 | 1.78 | 1.78 | 1.78 | 1.78 | 1.78 | 1.78 |
| amine oxide C₁₂-C₁₈ | 3.31 | 3.31 | 3.31 | 3.31 | — | — | — | — | — | 3.31 | 3.31 | — |
| sulfate | 0.49 | 0.49 | 0.49 | 0.49 | — | — | — | — | — | 0.49 | 0.49 | — |
| isoparaffinic hydrocarbon | 3.60 | — | — | — | — | — | — | — | 11.11 | — | — | — |
| d-limonene | — | 6.00 | 6.00 | 3.70 | 2.00 | 7.10 | 3.00 | 7.00 | — | 3.00 | 3.70 | 2.00 |
| Na n-decyl diphenyloxide | 1.00 | 4.00 | 4.00 | 1.25 | — | — | — | — | 2.29 | 1.00 | 1.25 | — |
| disulphonate | | | | | | | | | | | | |
| Na dodecyl diphenyloxide | — | — | — | — | 3.00 | 6.00 | 2.00 | 7.00 | — | — | — | 2.00 |
| disulphonate | | | | | | | | | | | | |
| DPM | 0.70 | — | — | — | — | — | — | — | — | — | — | — |
| fragrance | 0.20 | 0.20 | 0.20 | 0.20 | 0.20 | 0.20 | — | — | 0.20 | 0.20 | 0.20 | 0.20 |
| deionized water | q.s. | q.s. | q.s. | q.s. | q.s. | q.s. | q.s. | q.s. | q.s. | q.s. | q.s. | q.s. |

The viscosity of the compositions produced according to Table 5 was evaluated at ambient room temperature (20° C.) using a Brookfield LVF viscometer, using spindle #2, at 60 RPM; each of the formulations was manually shaken prior to testing. The results were reported in centipoise-seconds, and are listed on Table 6.

TABLE 6

| Example | Viscosity (cP) |
|---|---|
| N | 10-30 |
| O | 240-340 |
| P | 30-50 |
| Q | 10-30 |
| R | 10-30 |
| S | 30-50 |
| T | 20-40 |
| U | 40-60 |
| V | 140-220 |
| W | 10 |
| X | 10 |
| Y | 10 |

### EXAMPLE A, C, I, J, AND K

### Phase Separation

Certain of the compositions according to Table 1, and Table 3 were evaluated in order to determine their phase separation. After being produced by mixing as described above, the compositions were visually observed in order to determine when the first indications of phase separation appeared, and thereafter visually observed in order to determine when complete separation into two discernible clear layers was observed. These observations are reported on the following Table 7.

TABLE 7

| Ex- | | |
|---|---|---|
| ample | Initial Phase Separation* | Final Phase Separation** |
| A | 15 minutes - hazy upper layer | 4-5 hours, formed 2 clear layers |
| C | 30 minutes - hazy upper | 5-6 hours, formed 2 clear layers |
| | layer/hazy lower layer | |
| I | 30 minutes - hazy upper | 5-6 hours, formed 2 clear layers |
| | layer/hazy lower layer | |
| J | 30 minutes - hazy upper | 5-6 hours, formed 2 clear layers |
| | layer/hazy lower layer | |
| K | 30 minutes - hazy upper | 5-6 hours, formed 2 clear layers |
| | layer/hazy lower layer | |

*clear separation occurring but at least on of the layers are hazy
**phase separation forming 2 clear layers with essentially no turbidity

Each of the constituents in formulations reported in Table 1, Table 3, and Table 5 are indicated in % wt, water was provided in quantum sufficient to provide a total weight of 100% for each formulation.

The specific identity of the constituents used in the formulations according Table 1, Table 3, and Table 5 is presented in following Table 8.

TABLE 8

| | |
|---|---|
| sodium hypochlorite | an aqueous sodium hypochlorite solution about 12% |
| (12% active) | (ex. VWR International Ltd. Poole, Dorset UK) |
| sodium hydroxide | aqueous sodium hydroxide solution 50% (ex. VWR |
| (50% active) | International Ltd. Poole, Dorset UK) |
| isopropanol | supplied as isopropanol (ex. Haymen Ltd. Witham, |
| | Essex UK) |
| oleic acid | supplied as PRIOLENE ® 6992 (ex. Uniquema/Anstead |
| (about 98% wt. actives) | Intl.) or EMERSOL 213 (ex Cognis) |
| alkoxylated linear alcohol | C₁₃-C₁₅ ethoxylated linear alcohol, avg. 3 EO per |
| (100% wt. actives) | molecule, supplied as LUTENSOL A03 (ex. BASF AG) |
| alkoxylated fatty alcohol | C₁₂-C₁₈ mixed (linear and branched) alcohol, |
| (90-100% wt. actives) | alkoxylated with ethoxy and butoxy groups, supplied as |
| | PLURAFAC LF22 (ex. BASE AG) |
| alcohol ethoxylate | C₁₂-C₁₅ primary alcohol ethoxylate, avg. 3 EO per |
| (100% wt actives) | molecule, supplied as NEODOL 25/3 (ex. Shell Chem.) |
| amine oxide C₁₀-C₁₆ | alkyl C₁₀-C₁₆ dimethyl amine oxide, supplied as |
| (30% active) | EMPIGEN OB (ex. Hunstmann Chem. Co.) |
| amine oxide C₁₂-C₁₈ | alkyl C₁₂-C₁₈ dimethyl amine oxide, supplied as |
| (30% active) | AROMOX BW220 (ex. Akso-Nobel) |
| Sulfosuccinate | sodium dioctyl sulfosuccinate, supplied as REWOPOL |
| (75% wt. actives) | SBDO 75 (ex. Goldschmidt AG) or as MACKANATE |
| | DOS-75 |
| Sulfate (40% wt. actives) | sodium 2-ethylhexyl sulfate, supplied as REWOPOL |
| | D510 (ex. Goldschmidt AG) or RHODAPON BOS (ex. |
| | Rhodia) |
| isoparaffinic hydrocarbon | technical grade mixture of isoparaffinic hydrocarbons, |
| | supplied as ISOPAR E (ex. ExxonMobil Chemical Co.) |
| d-limonene | Ref. No. 10901430003, ex Inernatio N.V., Belgium |
| pine oil | SA133379, ex R.C. Treat & Co. Ltd., UK |
| orange oil terpene | SA133377, ex R.C. Treat & Co. Ltd., UK |
| cycloparaffinic hydrocarbons | technical grade mixture of cycloparaffinic hydrocarbons |
| | supplied as Nappar ® 6 (ex. ExxonMobil Chemical Co.) |
| DPM (dipropylene glycol | supplied as DOWANOL DPM (ex. Dow Chemical Co.) |
| monomethyl ether) | |
| sodium n-decyl diphenyloxide | supplied as DOWFAX 3B2 (ex. Dow Chemical Co.) |
| disulphonate | |
| (45% wt actives) | |
| sodium dodecyl diphenyloxide | supplied as DOWFAX 2A1 (ex. Dow Chemical Co.) |
| disulphonate | |
| (45% wt actives) | |
| fragrance | The fragrance comprises agrumex, decalactone |
| | gamma, manzanate, tetrahydolinalol, peonile, |
| | galbanone, diphenyloxide, damascenone total, |
| | galaxolide and hexyl isobutyrate. |
| deionized water | deionized water |

1. A fragranced bleaching composition, which composition comprises at least two visually distinct phases, there being an aqueous phase containing a bleach constituent and a hydrophobic phase that is a water-in-oil microemulstion, the fragrance being dissolved in the oil phase.

2. A fragranced bleaching composition according to claim 1 wherein the composition when mixed provides a viscosity of at least 5 cP.

3. A process for improving the fragrance stability of a liquid-bleach containing composition in which fragrance is incorporated which process includes the steps of forming a fragranced bleaching composition comprising an aqueous phase containing a bleach constituent, and a hydrophobic phase in form of a water-in-oil microemulsion wherein a continuous water-insoluble oil phase comprising a fragrance.

4. A process for bleaching an article which comprises the step of: contacting the article with a bleaching effective amount of the fragranced bleaching compositions according to claim 1.

5. A process for sanitizing a non-porous article which comprises the step of: contacting the article with a sanitizing effective amount of the fragranced bleaching composition according to claim 1.

6. A process for bleaching an article which comprises the step of: contacting the article with a bleaching effective amount of the fragranced bleaching compositions according to claim 2.

7. A process for bleaching an article which comprises the step of: contacting the article with a bleaching effective amount of the fragranced bleaching compositions according to claim 3.

8. A process for sanitizing a non-porous article which comprises the step of: contacting the article with a sanitizing effective amount of the fragranced bleaching composition according to claim 2.
